(19) United States
(12) Patent Application Publication
(10) Pub. No.: US 2024/0349250 A1
(43) Pub. Date: Oct. 17, 2024

(54) TRANSMISSION ENHANCEMENT METHOD, AND APPARATUS

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/681,469

(22) PCT Filed: Aug. 10, 2021
(86) PCT No.: PCT/CN2021/111892

§ 371 Date: Feb. 5, 2024

(51) Int. Cl. H04W 72/04; H04W 72/232

(52) U.S. Cl. CPC H04W 72/04; H04W 72/232

(57) ABSTRACT

Disclosed in embodiments of the present application are a transmission enhancement method and an apparatus using said method, which are applicable in a non-terrestrial network (NTN) communication system. The method includes: in response to an uplink transmission failure, a terminal device determines a transmission parameter used for uplink transmission on the basis of detected preset information, wherein the preset information includes a predefined signal sent by a network device or downlink control information sent by a network device; and executing uplink transmission on the basis of the determined transmission parameter.

### CROSS-REFERENCE TO RELATED APPLICATIONS

The present application is a U.S. National Stage of International Application No. PCT/CN2021/111892, filed on Aug. 10, 2021, the contents of which are incorporated herein by reference in their entireties for all purposes.

### BACKGROUND

### Technical Field

The present disclosure relates to the field of communication technologies, and more particularly, to a method and apparatus for transmission enhancement.

### Description of the Related Art

Non-Terrestrial Network (NTN) communication, especially satellite communication, has been included in the discussion of 3rd Generation Partnership Project (3GPP) 5th Generation Mobile Communication Technology (5G) standards due to its characteristics of wide coverage, strong disaster resistance, and large capacity. In the 3GPP “5G New Radio for ‘Non-Terrestrial Networks’ supported” research project, TR38.811 (Rel-15) reports research on deployment scenarios of NTN networks and channel models of the NTN networks, and TR38.821 (Rel-16) reports research on an architecture of NTN-based Next Generation Radio Access Networks (NG-RAN), and also defines and evaluates a solution for a network architecture that integrates a NTN network and a 5G network. The NTN can not only serve as a supplement to terrestrial networks (5G networks) to provide continuous services (such as maritime and high-speed rail) for Machine to Machine (M2M)/Internet of Things (IoT) devices and mobile platform users, enhancing the reliability of the 5G networks, or directly provide broadcast or multicast services to user devices at an edge of the network, enhancing the scalability of the 5G networks; but also can operate independently to provide unique services for remote areas, isolated islands, etc., making network services ubiquitous.

### SUMMARY

Embodiments of the present disclosure provide a method and apparatus for transmission enhancement, which may be applied to a Non-Terrestrial Network (NTN) communication system.

In a first aspect, embodiments of the present disclosure provide a method for transmission enhancement, which is performed by a terminal device. The method includes, in response to an uplink transmission failure, determining, based on detected preset information, a transmission parameter for an uplink transmission; wherein the preset information includes a predefined signal sent by a network device, or downlink control information sent by the network device, and performing the uplink transmission based on the determined transmission parameter.

In a second aspect, embodiments of the present disclosure provide another method for transmission enhancement, which is applied to a network device. The method includes sending a predefined signal to a terminal device or sending configuration information to the terminal device.

In a third aspect, embodiments of the present disclosure provide a communication device with some or all of functions of the terminal device implementing the method described in the first aspect. For example, the function of the communication device may have functions in some or all of embodiments in the present disclosure, or may have a function for independently implementing any of embodiments in the present disclosure. The function may be implemented by hardware, or may be implemented by hardware executing corresponding software. The hardware or software includes one or more units or modules corresponding to the above functions.

In a fourth aspect, embodiments of the present disclosure provide another communication device with some or all of functions of the network device implementing the method described in the second aspect. For example, the function of the communication device may have functions in some or all of embodiments in the present disclosure, or may have a function for independently implementing any of embodiments in the present disclosure. The function may be implemented by hardware, or may be implemented by hardware executing corresponding software. The hardware or software includes one or more units or modules corresponding to the above functions.

In a fifth aspect, embodiments of the present disclosure provide a communication device, including a processor, wherein the processor, when calling a computer program in a memory, executes the method described in the first aspect.

In a sixth aspect, embodiments of the present disclosure provide a communication device, including a processor, wherein the processor, when calling a computer program in a memory, executes the method described in the second aspect.

In a seventh aspect, embodiments of the present disclosure provide a communication device, including a processor and a memory, wherein a computer program is stored in the memory, and the processor executes the computer program stored in the memory to cause the communication device to execute the method described in the first aspect.

In an eighth aspect, embodiments of the present disclosure provide a communication device, including a processor and a memory, wherein a computer program is stored in the memory, and the processor executes the computer program stored in the memory to cause the communication device to execute the method described in the second aspect.

In a ninth aspect, embodiments of the present disclosure provide a communication device, including a processor and an interface circuit, wherein the interface circuit is configured to receive code instructions and transmit them to the processor, and the processor is configured to run the code instructions to cause the communication device to execute the method described in the first aspect.

In a tenth aspect, embodiments of the present disclosure provide a communication device, including a processor and an interface circuit, wherein the interface circuit is configured to receive code instructions and transmit them to the processor, and the processor is configured to run the code instructions to cause the communication device to execute the method described in the second aspect.

In an eleventh aspect, embodiments of the present disclosure provide a communication system, including the communication device described in the third aspect and the communication device described in the fourth aspect, or including the communication device described in the fifth aspect and the communication device described in the sixth aspect, or including the communication device described in the seventh aspect and the communication device described in the eighth aspect, or including the communication device described in the ninth aspect and the communication device described in the tenth aspect.

In a twelfth aspect, embodiments of the present disclosure provide a non-transitory computer-readable storage medium configured to store instructions used by the above terminal device, wherein the instructions, when executed, cause the terminal device to execute the method described in the first aspect.

In a thirteenth aspect, embodiments of the present disclosure provide a non-transitory readable storage medium configured to store instructions used by the above network device, wherein the instructions, when executed, cause the network device to execute the method described in the second aspect.

In a fourteenth aspect, the present disclosure further provides a computer program product including a computer program, which, when running on a computer, causes the computer to execute the method described in the first aspect.

In a fifteenth aspect, the present disclosure further provides a computer program product including a computer program, which, when running on a computer, causes the computer to execute the method described in the second aspect.

In a sixteenth aspect, the present disclosure provides a computer program, which, when running on a computer, causes the computer to execute the method described in the first aspect.

In a seventeenth aspect, the present disclosure provides a computer program, which, when running on a computer, causes the computer to execute the method described in the second aspect.

### BRIEF DESCRIPTION OF THE DRAWINGS

In order to more clearly illustrate technical solutions in embodiments of the present disclosure or background technologies, the drawings required for describing the embodiments of the present disclosure or the background technologies will be described below.

FIG. 1 is a schematic architectural diagram of a communication system provided by an embodiment of the present disclosure;

FIG. 2 is a flowchart of a method for transmission enhancement provided by an embodiment of the present disclosure;

FIG. 3 is a flowchart of another method for transmission enhancement provided by an embodiment of the present disclosure;

FIG. 4 is a flowchart of another method for transmission enhancement provided by an embodiment of the present disclosure;

FIG. 5 is a flowchart of yet another method for transmission enhancement provided by an embodiment of the present disclosure;

FIG. 6 is a schematic structural diagram of a communication device provided by an embodiment of the present disclosure; and

FIG. 7 is a schematic structural diagram of another communication device provided by an embodiment of the present disclosure.

### DETAILED DESCRIPTION OF THE PREFERRED EMBODIMENTS

Embodiments of the present disclosure are described in detail below, and examples of the embodiments are shown in the drawings, in which the same or similar reference numerals indicate the same or similar elements or elements having the same or similar functions throughout. The embodiments described below with reference to the drawings are illustrative, and are intended to explain the present disclosure, but should not be construed as limiting the present disclosure. In the description of the present disclosure, unless otherwise stated, “/” means “or”. For example, A/B may mean A or B. The expression “and/or” herein is just an association relationship describing associated objects, and means that three relationships may exist. For example, A and/or B may mean: A alone, B alone, and A and B together.

The terms “includes” and any variations thereof in the specification and claims of the present disclosure are intended to cover non-exclusive inclusion. For example, a process, method, system, product, or a device that includes a series of steps or units is not limited to the expressly listed steps or units, but also includes steps or units that are not expressly listed, or also includes other steps or units that are inherent to those processes, methods, products, or devices. In addition, in embodiments of the present disclosure, the word “illustrative” or “for example”, etc. is used to represent giving an example, an illustration, or a description. Any embodiment or design scheme described as “illustrative” or “for example” in embodiments of the present disclosure should not be explained as being more preferred or having more advantages than another embodiment or design scheme. Exactly, the use of the word “illustrative” or “example” or the like is intended to present a related concept in a specific manner.

It should be noted that the continuous emergence of new Internet applications, such as new-generation Augmented Reality (AR)/Virtual Reality (VR), vehicle-vehicle communication, has put forward higher requirements for wireless communication technologies, driving the continuous evolution of wireless communication technologies to meet application needs. At present, cellular mobile communication technologies are at an evolution stage of new-generation technologies. An important characteristic of the new-generation technologies is to support flexible configurations of various service types. The different service types have different requirements on the wireless communication technologies, for example, an enhanced Mobile Broad Band (eMBB) service type mainly requires a large bandwidth, a high speed, etc., an Ultra Reliable Low Latency Communication (URLLC) service type mainly requires high reliability and low latency, and a massive Machine Type Communication (mMTC) service type mainly requires a large connection number, so a new-generation wireless communication system requires a flexible and configurable design to support transmission of various service types.

In the research of the wireless communication technologies, satellite communication is considered to be an important aspect in the future development of the wireless communication technologies. The satellite communication refers to communication carried out by a radio communication device on the ground using satellites as relays. A satellite communication system consists of a satellite part and a ground part. Characteristics of the satellite communication are: a communication range is large; communication may be carried out between any two points as long as being within a range covered by radio waves emitted by the satellites; it is not easily affected by land disasters, that is, it has high reliability. As a supplement to the current terrestrial cellular communication system, satellite communication can have the following benefits.

1) Extended coverage: for areas that cannot be covered by the current cellular communication system or have high coverage costs, such as oceans, deserts, remote mountainous areas, etc., the communication problem can be solved through the satellite communication.

2) Emergency communication: under the condition that the infrastructure of the cellular communication is unavailable in an extreme case of disasters such as earthquakes, the satellite communication can be used to quickly establish communication connections.

3) Provide industrial applications: for example, for a delay sensitive service with long-distance transmission, the delay of service transmission can be reduced through the satellite communication.

It can be predicted that in the future wireless communication system, the satellite communication system and the terrestrial cellular communication system will gradually achieve deep integration and truly realize the intelligent connection of all things.

NTN communication, especially satellite communication, has been included in the discussion of 3GPP 5G standards due to its characteristics of wide coverage, strong disaster resistance, and large capacity. In the 3GPP “5G New Radio for ‘Non-Terrestrial Networks’ supported” research project, TR38.811 (Rel-15) reports research on deployment scenarios of NTN networks and channel models of the NTN networks, and TR38.821 (Rel-16) reports research on an architecture of NG-RAN, and also defines and evaluates a solution for a network architecture that integrates a NTN network and a 5G network. The NTN can not only serve as a supplement to terrestrial networks (5G networks) to provide continuous services (such as maritime and high-speed rail) for M2M/IoT devices and mobile platform users, enhancing the reliability of the 5G networks, or directly provide broadcast or multicast services to user devices at an edge of the network, enhancing the scalability of the 5G networks; but also can operate independently to provide unique services for remote areas, isolated islands, etc., making network services ubiquitous. Whether it is a satellite-ground integrated NTN or a standalone NTN, compared with a typical 5G network, it will have a great impact on coverage, user bandwidth, system capacity, service reliability or service availability, energy consumption, connection density and other performance, and can provide users with more reliable and consistent service experience, reducing network deployment costs for operators, connecting the multi-dimensional space of air, sky, earth and sea, forming an integrated ubiquitous network pattern.

However, in NTN system designs, transmission reliability of some channels, especially some uplink channels, is limited due to the limited air interface capabilities. The problem can be solved by introducing a pre-alert paging transmission in the existing solutions. However, by means of this method, the terminal still cannot guarantee the reliability of uplink transmission.

To this end, the present disclosure proposes a method for transmission enhancement, a communication device and a storage medium, and provides a coverage enhancement scheme applied to a satellite communication system, which can effectively improve a coverage performance in a satellite communication scenario, and ensure reliability of service transmission.

In order to better understand the method for transmission enhancement disclosed in embodiments of the present disclosure, a communication system used in embodiments of the present disclosure is first described below.

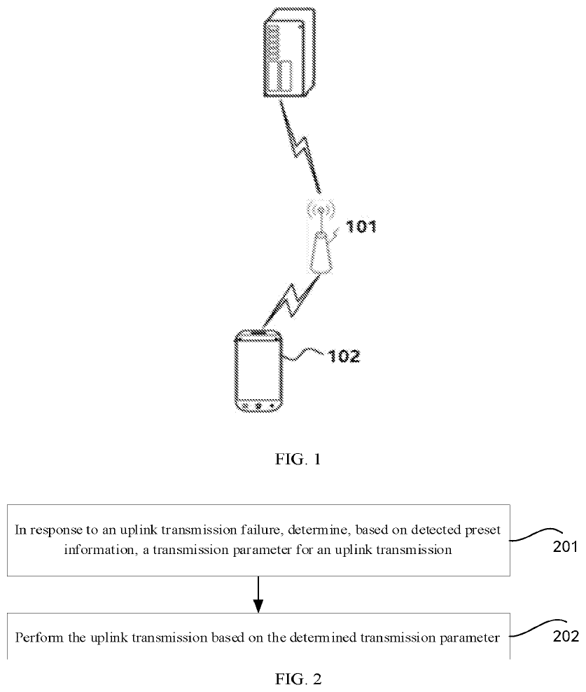

Please refer to FIG. 1, which is a schematic architectural diagram of a communication system provided by an embodiment of the present disclosure. The communication system may include, but is not limited to, one network device and one terminal device. The number and form of devices shown in FIG. 1 are used for examples only and do not constitute a limitation on embodiments of the present disclosure, and two or more network devices and two or more terminal devices may be included in practical applications. The communication system shown in FIG. 1 including one network device 101 and one terminal device 102 is taken as an example.

It should be noted that technical solutions of embodiments of the present disclosure may be applied to various communication systems, for example, long term evolution (LTE) systems, 5th generation (5G) mobile communication systems, 5G new radio (NR) systems, or other new mobile communication systems in the future.

The network device 101 in embodiments of the present disclosure is an entity on a network side for transmitting or receiving a signal. For example, the network device 101 may be an evolved NodeB (eNB), a transmission reception point (TRP), a next generation NodeB (gNB) in NR systems, a base station in other mobile communication systems in the future, or an access node in wireless fidelity (WiFi) systems. Embodiments of the present disclosure do not limit a specific technology and a specific implementation adopted by the network device. The network device provided in embodiments of the present disclosure may be composed of a central unit (CU) and a distributed unit (DU). The CU may also be referred to as a control unit. The CU-DU structure may be used to separate protocol layers of the network device, such as the base station, with some protocol layer functions placed under centralized control in the CU, and the remaining or all protocol layer functions distributed in the DU. The DU is centrally controlled by the CU.

The terminal device 102 in embodiments of the present disclosure is an entity on a user side for receiving or transmitting the signal, such as a mobile phone. The terminal device may also be referred to as a terminal, a user equipment (UE), a mobile station (MS), a mobile terminal (MT), etc. The terminal device may be vehicles with communication capabilities, intelligent vehicles, mobile phones, wearable devices, pads, computers with wireless transceiver capabilities, virtual reality (VR) terminal devices, augmented reality (AR) terminal devices, wireless terminal devices in industrial control, wireless terminal devices in self-driving, wireless terminal devices in remote medical surgery, wireless terminal devices in smart grid, wireless terminal devices in transportation safety, wireless terminal devices in smart city, wireless terminal devices in smart home, etc. Embodiments of the present disclosure do not limit a specific technology and a specific implementation adopted by the terminal device.

It can be understood that the communication system described in embodiments of the present disclosure is intended to more clearly explain technical solutions of embodiments of the present disclosure without constituting a limitation on the same. It is known to those of ordinary skill in the art, with the evolution of system architectures and the emergence of new service scenarios, the technical solutions of embodiments of the present disclosure are also applicable to similar technical problems.

The method and apparatus for transmission enhancement provided by the present disclosure will be introduced in details below with reference to the accompanying drawings.

Please refer to FIG. 2, which is a flowchart of a method for transmission enhancement provided by an embodiment of the present disclosure. It should be noted that the method for transmission enhancement in embodiments of the present disclosure may be applied to a terminal device. As shown in FIG. 2, the method for transmission enhancement may include but is not limited to steps 201 and 202.

In the step 201, in response to an uplink transmission failure, a transmission parameter for an uplink transmission is determined based on detected preset information, and the preset information includes a predefined signal sent by a network device, or downlink control information sent by the network device.

It should be noted that in embodiments of the present disclosure, a basis for the terminal device to determine that the uplink transmission fails may be a predefined criterion, for example, no response signal for the uplink transmission being received within a predefined time, no preconfigured downlink control information, preconfigured data or preconfigured pilot information being received within the predefined time. In an implementation of the present disclosure, the uplink transmission failure includes at least any one of A) to D).

A) No Response Signal for the Uplink Transmission is Received within the Predefined Time

In an implementation of the present disclosure, no response signal for the uplink transmission being received within the predefined time may include: no Random Access Response (RAR) signal for a Physical Random Access Channel (PRACH) signal is received within the predefined time; or no feedback information for a preset transmission is received within the predefined time, and the preset transmission is that the terminal device sends second data.

As an example, when the terminal device has sent the PRACH signal and does not receive the RAR signal within the predefined time, the terminal device determines that the uplink transmission fails.

As another example, when the terminal device has sent the second data and does not receive, within the predefined time, the feedback information for sending the second data, the terminal device determines that the uplink transmission fails.

B) No Preconfigured Downlink Control Information is Received within the Predefined Time

As an example, if the terminal device does not receive the transmission of the preconfigured downlink control information within the predefined time, the terminal device may determine that the uplink transmission fails.

C) No Preconfigured First Data is Received within the Predefined Time

As an example, if the terminal device does not receive the preconfigured first data within the predefined time, the terminal device may determine that the uplink transmission fails.

D) No Preconfigured Pilot Information is Received within the Predefined Time

As an example, if the terminal device does not receive the preconfigured pilot information within the predefined time, the terminal device may determine that the uplink transmission fails.

In some embodiments of the present disclosure, the predefined time may be given in a protocol. For example, the predefined time is preset in the protocol, and the terminal device may obtain the predefined time from the protocol to determine whether the uplink transmission failure occurs based on the predefined time.

In other embodiments of the present disclosure, the predefined time may be notified through a signaling by the network device to the terminal device in advance. The signaling at least includes any one of a higher layer signaling, a Medium Access Control (MAC) layer signaling, and a physical layer signaling. For example, the network device (such as a base station) notifies the terminal device in advance through the higher layer signaling (such as a system message), the MAC layer signaling or the physical layer signaling, so that the terminal device obtains the predefined time from the network device to determine whether the uplink transmission failure occurs based on the predefined time.

In embodiments of the present disclosure, after determining that the uplink transmission fails, the terminal device may determine the transmission parameter for the uplink transmission in the following two manners: one manner is to periodically detect the predefined signal sent by the network device to determine the transmission parameter for the uplink transmission, and the detection of the predefined signal sent by the network device may be a periodic detection; or the other manner may be to detect the downlink control information based on configuration information sent by the network device to determine the transmission parameter for the uplink transmission.

In an implementation of the present disclosure, the determined transmission parameter may include but is not limited to the number of repetitions, a transmission resource, a transmission beam, power information, etc.

In the step 202, the uplink transmission is performed based on the determined transmission parameter.

It should be noted that different uplink transmissions may have different transmission parameter information. In embodiments of the present disclosure, the terminal device may perform the uplink transmission based on the determined transmission parameter.

By implementing embodiments of the present disclosure, when it is determined that the uplink transmission fails, the transmission parameter for the uplink transmission may be determined based on the detected preset information, and the uplink transmission may be performed based on the determined transmission parameter, which can effectively improve the coverage performance in the satellite communication scenario and ensure the reliability of the service transmission.

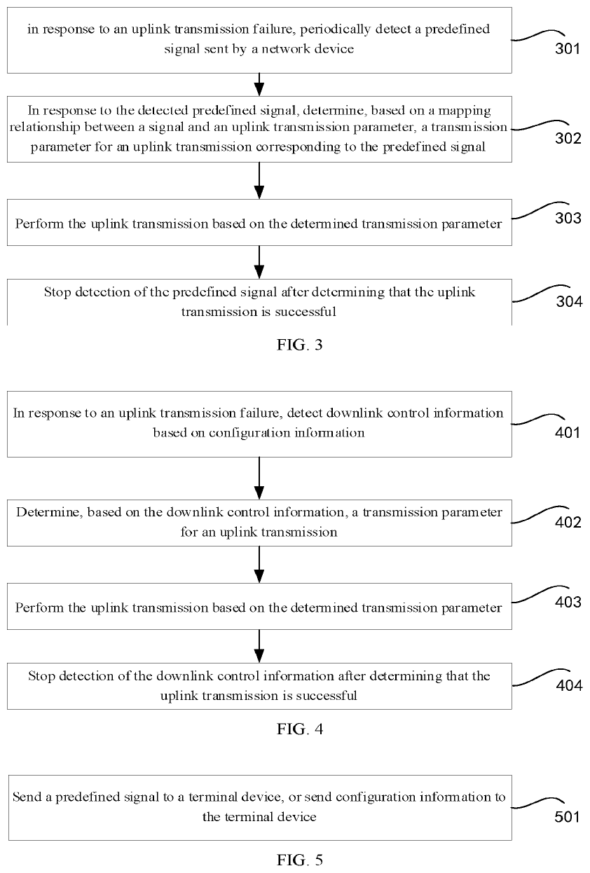

It should be noted that, after determining that the uplink transmission fails, the terminal device may determine the transmission parameter of the uplink transmission by periodically detecting the predefined signal sent by the network device. In an implementation of the present disclosure, FIG. 3 is a flowchart of another method for transmission enhancement provided by an embodiment of the present disclosure. It should be noted that the method for transmission enhancement in embodiments of the present disclosure may be applied to a terminal device. As shown in FIG. 3, the method for transmission enhancement in embodiments of the present disclosure may include but is not limited to steps 301 to 304.

In the step 301, in response to an uplink transmission failure, a predefined signal sent by a network device is periodically detected.

It should be noted that in embodiments of the present disclosure, a basis for the terminal device to determine that the uplink transmission fails may be a predefined criterion, for example, no response signal for the uplink transmission being received within a predefined time, no preconfigured downlink control information, preconfigured data or preconfigured pilot information being received within the predefined time. In an implementation of the present disclosure, the uplink transmission failure includes at least any one of A) to D).

A) No Response Signal for the Uplink Transmission is Received within the Predefined Time

In an implementation of the present disclosure, no response signal for the uplink transmission being received within the predefined time may include: no Random Access Response (RAR) signal for a Physical Random Access Channel (PRACH) signal is received within the predefined time; or no feedback information for a preset transmission is received within the predefined time, and the preset transmission is that the terminal device sends second data.

As an example, when the terminal device has sent the PRACH signal and does not receive the RAR signal within the predefined time, the terminal device determines that the uplink transmission fails.

As another example, when the terminal device has sent the second data and does not receive, within the predefined time, the feedback information for sending the second data, the terminal device determines that the uplink transmission fails.

B) No Preconfigured Downlink Control Information is Received within the Predefined Time

As an example, if the terminal device does not receive the transmission of the preconfigured downlink control information within the predefined time, the terminal device may determine that the uplink transmission fails.

C) No Preconfigured First Data is Received within the Predefined Time

As an example, if the terminal device does not receive the preconfigured first data within the predefined time, the terminal device may determine that the uplink transmission fails.

D) No Preconfigured Pilot Information is Received within the Predefined Time

As an example, if the terminal device does not receive the preconfigured pilot information within the predefined time, the terminal device may determine that the uplink transmission fails.

In some embodiments of the present disclosure, the predefined time may be given in a protocol. For example, the predefined time is preset in the protocol, and the terminal device may obtain the predefined time from the protocol to determine whether the uplink transmission failure occurs based on the predefined time.

In other embodiments of the present disclosure, the predefined time may be notified through a signaling by the network device to the terminal device in advance. The signaling at least includes any one of a higher layer signaling, a Medium Access Control (MAC) layer signaling, and a physical layer signaling. For example, the network device (such as a base station) notifies the terminal device in advance through the higher layer signaling (such as a system message), the MAC layer signaling or the physical layer signaling, so that the terminal device obtains the predefined time from the network device to determine whether the uplink transmission failure occurs based on the predefined time.

In embodiments of the present disclosure, after determining that the uplink transmission fails, the terminal device begins to periodically detect the predefined signal sent by the network device. The predefined signal may be one in a predefined signal set, and each signal in the predefined signal set has a mapping relationship with an uplink transmission parameter.

In embodiments of the present disclosure, the terminal device may detect, according to signal characteristic information and/or transmission time-frequency resource position information of the predefined signal that are learnt in advance, the predefined signal sent by the network device from the predefined signal set. For example, in order for the terminal device to accurately detect the predefined signal, the terminal device needs to learn the signal characteristic information (such as a signal sequence) of the predefined signal in advance, and detect, according to the signal characteristic information of the predefined signal, the predefined signal sent by the network device from the predefined signal set.

For another example, the terminal device needs to learn the transmission time-frequency resource position information of the predefined signal in advance, and detect, according to the transmission time-frequency resource position information of the predefined signal, the predefined signal sent by the network device from the predefined signal set.

For yet another example, the terminal device needs to learn the signal characteristic information and the transmission time-frequency resource position information of the predefined signal in advance, and detect, according to the signal characteristic information and the transmission time-frequency resource position information of the predefined signal, the predefined signal sent by the network device from the predefined signal set.

It should be noted that in embodiments of the present disclosure, the transmission time-frequency resource position information can be understood as a transmission position of a signal. The transmission time-frequency resource position information may include but is not limited to one or more of a period, an offset value, a frequency domain resource position, etc. The signal characteristic information and/or the transmission time-frequency resource position information of the predefined signal may be predefined. Alternatively, the signal characteristic information and/or the transmission time-frequency resource position information of the predefined signal may also be configured to the terminal device by the network device (such as the base station) through the signaling.

It should also be noted that in some embodiments of the present disclosure, a mapping relationship between the signal characteristic information of the predefined signal and the uplink transmission may also be predefined, or may also be configured to the terminal device by the network device through the signaling.

In the step 302, in response to the detected predefined signal, a transmission parameter for an uplink transmission corresponding to the predefined signal is determined based on a mapping relationship between a signal and an uplink transmission parameter.

In some embodiments of the present disclosure, after detecting the predefined signal sent by the network device, the terminal device may determine, based on the mapping relationship between the signal and the uplink transmission parameter, the transmission parameter for the uplink transmission corresponding to the predefined signal sent by the network device. The mapping relationship may be predefined, or may be configured to the terminal device by the network device through the signaling.

In an implementation of the present disclosure, the determined transmission parameter may include but is not limited to the number of repetitions, a transmission resource, a transmission beam, power information, etc.

In the step 303, the uplink transmission is performed based on the determined transmission parameter.

It should be noted that different uplink transmissions may have different transmission parameter information. In embodiments of the present disclosure, the terminal device may perform the uplink transmission based on the determined transmission parameter.

In some embodiments of the present disclosure, as shown in FIG. 3, the method for transmission enhancement in embodiments of the present disclosure may further include the step 304. In the step 304, after it is determined that the uplink transmission is successful, detection of the predefined signal is stopped.

In some embodiments of the present disclosure, after determining that the uplink transmission is successful, the terminal device stops detecting the predefined signal sent by the network device.

In embodiments of the present disclosure, a basis for the terminal device to determine the success of the uplink transmission may be that feedback information for the uplink transmission is received within the predefined time or other predefined criteria. For example, if the terminal device receives a response signal for the uplink transmission within a predefined time, the terminal device determines that the uplink transmission is successful and may stop detecting the predefined signal sent by the network device. For another example, if the terminal device receives transmission of preconfigured downlink control information within the predefined time, the terminal device determines that the uplink transmission is successful and may stop detecting the predefined signal sent by the network device. For yet another example, if the terminal device receives preconfigured data within the predefined time, the terminal device determines that the uplink transmission is successful and may stop detecting the predefined signal sent by the network device. For still another example, if the terminal device receives preconfigured pilot information within the predefined time, the terminal device determines that the uplink transmission is successful and may stop detecting the predefined signal sent by the network device.

In some embodiments of the present disclosure, the predefined time may be given in a protocol. Alternatively, the predefined time may also be notified through the signaling by the network device to the terminal device in advance. The signaling at least includes any one of a higher layer signaling, a Medium Access Control (MAC) layer signaling, and a physical layer signaling. For example, the network device (such as a base station) notifies the terminal device in advance through the higher layer signaling (such as a system message), the MAC layer signaling or the physical layer signaling, so that the terminal device obtains the predefined time from the network device to determine whether the uplink transmission failure occurs based on the predefined time.

By implementing embodiments of the present disclosure, after determining that the uplink transmission fails, the terminal device may periodically detect the predefined signal sent by the network device, and after detecting the predefined signal sent by the network device, determine, based on the mapping relationship between the signal and the uplink transmission parameter, the transmission parameter for the uplink transmission corresponding to the predefined signal, so that the terminal device may perform the uplink transmission based on the determined transmission parameter. It can be seen that the present disclosure provides the coverage enhancement solution applied to the satellite communication system, which can effectively improve the coverage performance in the satellite communication scenario and ensure the reliability of the service transmission.

It should be noted that after determining that the uplink transmission fails, the terminal device may detect the downlink control information based on the configuration information sent by the network device to determine the transmission parameter for the uplink transmission. FIG. 4 is a flowchart of another method for transmission enhancement provided by an embodiment of the present disclosure. It should be noted that the method for transmission enhancement in embodiments of the present disclosure may be applied to a terminal device. As shown in FIG. 4, the method for transmission enhancement in embodiments of the present disclosure may include but is not limited to steps 401 to 404.

In the step 401, in response to an uplink transmission failure, downlink control information is detected based on configuration information.

It should be noted that in embodiments of the present disclosure, a basis for the terminal device to determine that the uplink transmission fails may be a predefined criterion, for example, no response signal for the uplink transmission being received within a predefined time, no preconfigured downlink control information, preconfigured data or preconfigured pilot information being received within the predefined time. In an implementation of the present disclosure, the uplink transmission failure includes at least any one of A) to D).

A) No Response Signal for the Uplink Transmission is Received within the Predefined Time

In an implementation of the present disclosure, no response signal for the uplink transmission being received within the predefined time may include: no Random Access Response (RAR) signal for a Physical Random Access Channel (PRACH) signal is received within the predefined time; or no feedback information for a preset transmission is received within the predefined time, and the preset transmission is that the terminal device sends second data.

As an example, when the terminal device has sent the PRACH signal and does not receive the RAR signal within the predefined time, the terminal device determines that the uplink transmission fails.

As another example, when the terminal device has sent the second data and does not receive, within the predefined time, the feedback information for sending the second data, the terminal device determines that the uplink transmission fails.

B) No Preconfigured Downlink Control Information is Received within the Predefined Time

As an example, if the terminal device does not receive the transmission of the preconfigured downlink control information within the predefined time, the terminal device may determine that the uplink transmission fails.

C) No Preconfigured First Data is Received within the Predefined Time

As an example, if the terminal device does not receive the preconfigured first data within the predefined time, the terminal device may determine that the uplink transmission fails.

D) No Preconfigured Pilot Information is Received within the Predefined Time

As an example, if the terminal device does not receive the preconfigured pilot information within the predefined time, the terminal device may determine that the uplink transmission fails.

In some embodiments of the present disclosure, the predefined time may be given in a protocol. For example, the predefined time is preset in the protocol, and the terminal device may obtain the predefined time from the protocol to determine whether the uplink transmission failure occurs based on the predefined time.

In other embodiments of the present disclosure, the predefined time may be notified through a signaling by the network device to the terminal device in advance. The signaling at least includes any one of a higher layer signaling, a Medium Access Control (MAC) layer signaling, and a physical layer signaling. For example, the network device (such as a base station) notifies the terminal device in advance through the higher layer signaling (such as a system message), the MAC layer signaling or the physical layer signaling, so that the terminal device obtains the predefined time from the network device to determine whether the uplink transmission failure occurs based on the predefined time.

In embodiments of the present disclosure, after determining that the uplink transmission fails, the terminal device may detect the downlink control information based on the configuration information. In an implementation, the configuration information may be predefined, or the configuration information may also be notified by the network device to the terminal device through the signaling.

In an implementation of the present disclosure, the configuration information may include at least one of: pilot information for the downlink control information; detection of a Downlink Control Information (DCI) type of the downlink control information; the number of detections; a resource position; and an aggregation level. For example, the configuration information may include the pilot information for the downlink control information; the detection of the DCI type of the downlink control information; the number of detections; the resource position; the aggregation level and other information.

In the step 402, based on the downlink control information, a transmission parameter for an uplink transmission is determined.

In some embodiments of the present disclosure, the downlink control information may include transmission parameter adjustment downlink control information, or may include personal position information adjustment downlink control information and other information. In an implementation of the present disclosure, the downlink control information may include indication information for the transmission parameter or the personal position information. For example, the downlink control information may include the indication information for the transmission parameter, so that the terminal device may determine the transmission parameter for the uplink transmission based on the indication information. For another example, the downlink control information may include the indication information for the personal position information, so that the terminal device may determine the transmission parameter for the uplink transmission based on the indication information. For example, the terminal device may adjust the personal position information based on the personal position indication information.

In an implementation of the present disclosure, the determined transmission parameter may include but is not limited to the number of repetitions, a transmission resource, a transmission beam, power information, etc.

In the step 403, the uplink transmission is performed based on the determined transmission parameter.

It should be noted that different uplink transmissions may have different transmission parameter information. In embodiments of the present disclosure, the terminal device may perform the uplink transmission based on the determined transmission parameter. For example, the terminal device may correspondingly adjust the transmission parameter for the uplink transmission based on the downlink control information.

In some embodiments of the present disclosure, as shown in FIG. 4, the method for transmission enhancement in embodiments of the present disclosure may further include the step 404. In the step 404, after it is determined that the uplink transmission is successful, detection of the downlink control information is stopped. That is, after determining that the uplink transmission is successful, the terminal device stops detecting the downlink control information sent by the network device.

In embodiments of the present disclosure, a basis for the terminal device to determine the success of the uplink transmission may be that feedback information for the uplink transmission is received within the predefined time or other predefined criteria. For example, if the terminal device receives a response signal for the uplink transmission within a predefined time, the terminal device determines that the uplink transmission is successful and may stop detecting the downlink control information. For another example, if the terminal device receives transmission of preconfigured downlink control information within the predefined time, the terminal device determines that the uplink transmission is successful and may stop detecting the downlink control information. For yet another example, if the terminal device receives preconfigured data within the predefined time, the terminal device determines that the uplink transmission is successful and may stop detecting the downlink control information. For still another example, if the terminal device receives preconfigured pilot information within the predefined time, the terminal device determines that the uplink transmission is successful and may stop detecting the downlink control information.

In some embodiments of the present disclosure, the predefined time may be given in a protocol. Alternatively, the predefined time may also be notified through the signaling by the network device to the terminal device in advance. The signaling at least includes any one of a higher layer signaling, a Medium Access Control (MAC) layer signaling, and a physical layer signaling. For example, the network device (such as a base station) notifies the terminal device in advance through the higher layer signaling (such as a system message), the MAC layer signaling or the physical layer signaling, so that the terminal device obtains the predefined time from the network device to determine whether the uplink transmission failure occurs based on the predefined time.

By implementing embodiments of the present disclosure, after determining that the uplink transmission fails, the terminal device may detect the downlink control information based on the configuration information, and determine the transmission parameter for the uplink transmission based on the downlink control information, so that the terminal device may perform the uplink transmission based on the determined transmission parameter. It can be seen that the present disclosure provides the coverage enhancement solution applied to the satellite communication system, which can effectively improve the coverage performance in the satellite communication scenario and ensure the reliability of the service transmission.

It can be understood that the above embodiments are implementations of the method for transmission enhancement of embodiments of the present disclosure described from the terminal device side. Embodiments of the present disclosure further provide a method for transmission enhancement. An implementation of the method for transmission enhancement will be described below from a network device side. Please refer to FIG. 5, which is a flowchart of yet another method for transmission enhancement provided by an embodiment of the present disclosure. It should be noted that the method for transmission enhancement in embodiments of the present disclosure may be applied to a network device. As shown in FIG. 5, the method for transmission enhancement may include but is not limited to step 501.

In the step 501, a predefined signal is sent to a terminal device, or configuration information is sent to the terminal device.

In some embodiments of the present disclosure, the network device may send the predefined signal to the terminal device. After determining that the uplink transmission fails, the terminal device may periodically detect the predefined signal sent by the network device. After detecting the predefined signal, the terminal device may determine, based on a mapping relationship between a signal and an uplink transmission parameter, a transmission parameter for the uplink transmission corresponding to the predefined signal, so as to perform the uplink transmission based on the determined transmission parameter. In an implementation of the present disclosure, the determined transmission parameter may include but is not limited to the number of repetitions, a transmission resource, a transmission beam, power information, etc.

It should be noted that in embodiments of the present disclosure, a basis for the terminal device to determine that the uplink transmission fails may be a predefined criterion, for example, no response signal for the uplink transmission being received within a predefined time, no preconfigured downlink control information, preconfigured data or preconfigured pilot information being received within the predefined time. In an implementation of the present disclosure, the uplink transmission failure includes at least any one of A) to D).

A) No Response Signal for the Uplink Transmission is Received within the Predefined Time

In an implementation of the present disclosure, no response signal for the uplink transmission being received within the predefined time may include: no Random Access Response (RAR) signal for a Physical Random Access Channel (PRACH) signal is received within the predefined time; or no feedback information for a preset transmission is received within the predefined time, and the preset transmission is that the terminal device sends second data.

As an example, when the terminal device has sent the PRACH signal and does not receive the RAR signal within the predefined time, the terminal device determines that the uplink transmission fails.

As another example, when the terminal device has sent the second data and does not receive, within the predefined time, the feedback information for sending the second data, the terminal device determines that the uplink transmission fails.

B) No Preconfigured Downlink Control Information is Received within the Predefined Time

As an example, if the terminal device does not receive the transmission of the preconfigured downlink control information within the predefined time, the terminal device may determine that the uplink transmission fails.

C) No Preconfigured First Data is Received within the Predefined Time

As an example, if the terminal device does not receive the preconfigured first data within the predefined time, the terminal device may determine that the uplink transmission fails.

D) No Preconfigured Pilot Information is Received within the Predefined Time

As an example, if the terminal device does not receive the preconfigured pilot information within the predefined time, the terminal device may determine that the uplink transmission fails.

In some embodiments of the present disclosure, the predefined time may be given in a protocol. For example, the predefined time is preset in the protocol, and the terminal device may obtain the predefined time from the protocol to determine whether the uplink transmission failure occurs based on the predefined time.

In other embodiments of the present disclosure, the predefined time may be notified through a signaling by the network device to the terminal device in advance. The signaling at least includes any one of a higher layer signaling, a Medium Access Control (MAC) layer signaling, and a physical layer signaling. For example, the network device (such as a base station) notifies the terminal device in advance through the higher layer signaling (such as a system message), the MAC layer signaling or the physical layer signaling, so that the terminal device obtains the predefined time from the network device to determine whether the uplink transmission failure occurs based on the predefined time.

In embodiments of the present disclosure, after determining that the uplink transmission fails, the terminal device begins to periodically detect the predefined signal sent by the network device. The predefined signal may be one in a predefined signal set, and each signal in the predefined signal set has a mapping relationship with an uplink transmission parameter.

In embodiments of the present disclosure, the terminal device may detect, according to signal characteristic information and/or transmission time-frequency resource position information of the predefined signal that are learnt in advance, the predefined signal sent by the network device from the predefined signal set. For example, in order for the terminal device to accurately detect the predefined signal, the terminal device needs to learn the signal characteristic information (such as a signal sequence) of the predefined signal in advance, and detect, according to the signal characteristic information of the predefined signal, the predefined signal sent by the network device from the predefined signal set.

For another example, the terminal device needs to learn the transmission time-frequency resource position information of the predefined signal in advance, and detect, according to the transmission time-frequency resource position information of the predefined signal, the predefined signal sent by the network device from the predefined signal set.

For yet another example, the terminal device needs to learn the signal characteristic information and the transmission time-frequency resource position information of the predefined signal in advance, and detect, according to the signal characteristic information and the transmission time-frequency resource position information of the predefined signal, the predefined signal sent by the network device from the predefined signal set.

It should be noted that in embodiments of the present disclosure, the transmission time-frequency resource position information can be understood as a transmission position of a signal. The transmission time-frequency resource position information may include but is not limited to one or more of a period, an offset value, a frequency domain resource position, etc. The signal characteristic information and/or the transmission time-frequency resource position information of the predefined signal may be predefined. Alternatively, the signal characteristic information and/or the transmission time-frequency resource position information of the predefined signal may also be configured to the terminal device by the network device (such as the base station) through the signaling.

It should also be noted that in some embodiments of the present disclosure, a mapping relationship between the signal characteristic information of the predefined signal and the uplink transmission may also be predefined, or may also be configured to the terminal device by the network device through the signaling.

In an implementation of the present disclosure, the network device may send configuration information to the terminal device. After determining that the uplink transmission fails, the terminal device detects downlink control information based on the configuration information sent by the network device, and determines, based on the downlink control information, the transmission parameter for the uplink transmission to perform the uplink transmission based on the determined transmission parameter.

It should be noted that in embodiments of the present disclosure, a basis for the terminal device to determine that the uplink transmission fails may be a predefined criterion, for example, no response signal for the uplink transmission being received within a predefined time, no preconfigured downlink control information, preconfigured data or preconfigured pilot information being received within the predefined time. In an implementation of the present disclosure, the uplink transmission failure includes at least any one of A) to D).

A) No Response Signal for the Uplink Transmission is Received within the Predefined Time

In an implementation of the present disclosure, no response signal for the uplink transmission being received within the predefined time may include: no Random Access Response (RAR) signal for a Physical Random Access Channel (PRACH) signal is received within the predefined time; or no feedback information for a preset transmission is received within the predefined time, and the preset transmission is that the terminal device sends second data.

As an example, when the terminal device has sent the PRACH signal and does not receive the RAR signal within the predefined time, the terminal device determines that the uplink transmission fails.

As another example, when the terminal device has sent the second data and does not receive, within the predefined time, the feedback information for sending the second data, the terminal device determines that the uplink transmission fails.

B) No Preconfigured Downlink Control Information is Received within the Predefined Time

As an example, if the terminal device does not receive the transmission of the preconfigured downlink control information within the predefined time, the terminal device may determine that the uplink transmission fails.

C) No Preconfigured First Data is Received within the Predefined Time

As an example, if the terminal device does not receive the preconfigured first data within the predefined time, the terminal device may determine that the uplink transmission fails.

D) No Preconfigured Pilot Information is Received within the Predefined Time

As an example, if the terminal device does not receive the preconfigured pilot information within the predefined time, the terminal device may determine that the uplink transmission fails.

In some embodiments of the present disclosure, the predefined time may be given in a protocol. For example, the predefined time is preset in the protocol, and the terminal device may obtain the predefined time from the protocol to determine whether the uplink transmission failure occurs based on the predefined time.

In other embodiments of the present disclosure, the predefined time may be notified through a signaling by the network device to the terminal device in advance. The signaling at least includes any one of a higher layer signaling, a Medium Access Control (MAC) layer signaling, and a physical layer signaling. For example, the network device (such as a base station) notifies the terminal device in advance through the higher layer signaling (such as a system message), the MAC layer signaling or the physical layer signaling, so that the terminal device obtains the predefined time from the network device to determine whether the uplink transmission failure occurs based on the predefined time

In embodiments of the present disclosure, after determining that the uplink transmission fails, the terminal device may detect the downlink control information based on the configuration information. In an implementation, the configuration information may be predefined, or the configuration information may also be notified by the network device to the terminal device through the signaling.

In an implementation of the present disclosure, the configuration information may include at least one of: pilot information for the downlink control information; detection of a Downlink Control Information (DCI) type of the downlink control information; the number of detections; a resource position; and an aggregation level. For example, the configuration information may include the pilot information for the downlink control information; the detection of the DCI type of the downlink control information; the number of detections; the resource position; the aggregation level and other information.

In some embodiments of the present disclosure, the downlink control information may include transmission parameter adjustment downlink control information, or may include personal position information adjustment downlink control information and other information. In an implementation of the present disclosure, the downlink control information may include indication information for the transmission parameter or the personal position information. For example, the downlink control information may include the indication information for the transmission parameter, so that the terminal device may determine the transmission parameter for the uplink transmission based on the indication information. For another example, the downlink control information may include the indication information for the personal position information, so that the terminal device may determine the transmission parameter for the uplink transmission based on the indication information. For example, the terminal device may adjust the personal position information based on the personal position indication information.

In an implementation of the present disclosure, the determined transmission parameter may include but is not limited to the number of repetitions, a transmission resource, a transmission beam, power information, etc.

By implementing embodiments of the present disclosure, the predefined signal or the configuration information is sent to the terminal device by the network device, so that the terminal device determines the transmission parameter for the uplink transmission based on detecting the predefined signal or the configuration information sent by the network device, which enables the terminal device to perform the uplink transmission based on the determined transmission parameter. It can be seen that the present disclosure provides the coverage enhancement solution applied to the satellite communication system, which can effectively improve the coverage performance in the satellite communication scenario and ensure the reliability of the service transmission.

In the above embodiments provided by the present disclosure, the methods provided by embodiments of the present disclosure are introduced from the perspectives of the terminal device and the network device. In order to achieve various functions of the methods provided in embodiments of the present disclosure, the network device and the terminal device may include hardware structures and software modules, and the various functions are implemented in the form of hardware structures, software modules, or hardware structures plus software modules. One of the various functions may be implemented in the form of hardware structures, software modules, or hardware structure plus software modules.

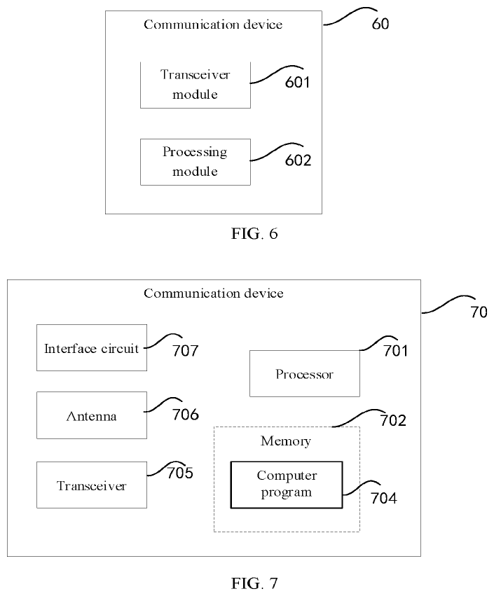

Please refer to FIG. 6, which is a schematic structural diagram of a communication device 60 provided by an embodiment of the present disclosure. The communication device 60 shown in FIG. 6 may include a transceiver module 601 and a processing module 602. The transceiver module 601 may include a transmitting module and/or a receiving module. The transmitting module is configured to implement a transmission function, and the receiving module is configured to implement a reception function. The transceiver module 601 may implement the transmission function and/or the reception function.

The communication device 60 may be a terminal device, a device in the terminal device, or a device that can be used in conjunction with the terminal device. Alternatively, the communication device 60 may be a network device, a device in the network device, or a device that can be used in conjunction with the network device.

The communication device 60 is the terminal device: in embodiments of the present disclosure, the processing module 602 is configured to: in response to an uplink transmission failure, determine, based on detected preset information, a transmission parameter for an uplink transmission, and perform the uplink transmission based on the determined transmission parameter, the preset information includes a predefined signal sent by a network device or downlink control information sent by the network device.

In an implementation of the present disclosure, the processing module 602 is configured to: periodically detect the predefined signal sent by the network device; and in response to the detected predefined signal, determine, based on a mapping relationship between a signal and an uplink transmission parameter, the transmission parameter for the uplink transmission corresponding to the predefined signal.

In an implementation of the present disclosure, the processing module 602 is configured to: detect, according to signal characteristic information and/or transmission time-frequency resource position information of the predefined signal that are learnt in advance, the predefined signal sent by the network device from a predefined signal set.

In an implementation of the present disclosure, the signal characteristic information and/or the transmission time-frequency resource position information are respectively predefined; or the signal characteristic information and/or the transmission time-frequency resource position information are respectively configured to the terminal device by the network device through a signaling.

In an implementation of the present disclosure, the processing module 602 is further configured to stop detection of the predefined signal after determining that the uplink transmission is successful.

In an implementation of the present disclosure, the processing module 602 is configured to: detect the downlink control information based on configuration information; and determine, based on the downlink control information, the transmission parameter for the uplink transmission.

In an implementation of the present disclosure, the configuration information includes at least one of: pilot information for the downlink control information; detection of a Downlink Control Information (DCI) type of the downlink control information; a number of detections; a resource position; or an aggregation level.

In an implementation of the present disclosure, the downlink control information includes indication information for the transmission parameter or personal position information.

In an implementation of the present disclosure, the processing module is further configured to stop detection of the downlink control information after determining that the uplink transmission is successful.

In an implementation of the present disclosure, the uplink transmission failure includes at least any one of: no response signal for the uplink transmission being received within a predefined time; no preconfigured downlink control information being received within the predefined time; no preconfigured first data being received within the predefined time; or no preconfigured pilot information being received within the predefined time.

In an implementation of the present disclosure, no response signal for the uplink transmission being received within the predefined time includes no Random Access Response (RAR) signal for a Physical Random Access Channel (PRACH) signal being received within the predefined time; or no feedback information for a preset transmission being received within the predefined time, and the preset transmission is that second data is sent by the terminal device.

In an implementation of the present disclosure, the predefined time is given in a protocol; or, the predefined time is notified by the network device to the terminal device through a signaling in advance, and the signaling includes at least any one of a higher layer signaling, a medium access control layer signaling and a physical layer signaling.

The communication device 60 is the network device: in embodiments of the present disclosure, the transceiver module 601 is configured to send a predefined signal to a terminal device, or send configuration information to the terminal device.

In an implementation of the present disclosure, the processing module 602 is configured to respectively configure for the terminal device, through a signaling, signal characteristic information and/or transmission time-frequency resource position information of the predefined signal.

In an implementation of the present disclosure, the configuration information includes at least one of: pilot information for the downlink control information; detection of a Downlink Control Information (DCI) type of the downlink control information; the number of detections; a resource position; or an aggregation level.

Regarding the devices in the above embodiments, a specific manner in which each module executes operations has been described in detail in embodiments related to the method, and will not be described in detail here.

Please refer to FIG. 7, which is a schematic structural diagram of another communication device 70 provided by an embodiment of the present disclosure. The communication device 70 may be a network device, or may be a terminal device, or may be a chip, a chip system, a processor or the like that supports the network device to implement the above method, or may be a chip, a chip system, a processor or the like that supports the terminal device to implement the above method. The device can be used to implement the method described in the above method embodiments. For details, reference may be made to the description in the above method embodiments.

The communication device 70 may include one or more processors 701. The processor 701 may be a general-purpose processor or a dedicated processor, or the like. For example, the processor 701 may be a baseband processor or a central processing unit. The baseband processor can be used to process communication protocols and communication data. The central processor can be used to control the communication devices (such as base stations, baseband chips, terminal devices, terminal device chips, DU or CU, or the like), execute computer programs, and process data for the computer programs.

In embodiments of the present disclosure, the communication device 70 may also include one or more memories 702, on which a computer program 704 may be stored. The processor 701 executes the computer program 704, so that the communication device 70 performs the method described in the above method embodiments. In embodiments of the present disclosure, the memory 702 may also store data. The communication device 70 and the memory 702 can be provided separately or integrated together.

In embodiments of the present disclosure, the communication device 70 may also include a transceiver 705 and an antenna 706. The transceiver 705 may be referred to as a transceiver unit, a transceiver, a transceiver circuit, or the like, and is used to implement transceiver functions. The transceiver 705 may include a receiver and a transmitter. The receiver may be referred to as a receiver or a receiving circuit, or the like, and is used to implement the receiving function; and the transmitter may be referred to as a transmitter, a transmitting circuit, or the like, and is used to implement the transmitting function.

In embodiments of the present disclosure, the communication device 70 may also include one or more interface circuits 707. The interface circuit 707 is used to receive code instructions and transmit the code instructions to the processor 701. The processor 701 executes the code instructions to cause the communication device 70 to perform the method described in the above method embodiments.

The communication device 70 is a terminal device: the processor 701 is configured to execute the step 201 and the step 202 in FIG. 2; execute the step 301, the step 302, the step 303 and the step 304 in FIG. 3; and execute the step 401, the step 402, the step 403 and the step 404 in FIG. 4.

The communication device 70 is a network device: the transceiver 705 is configured to execute the step 501 in FIG. 5.

In an implementation of the present disclosure, the processor 701 may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The above-mentioned transceiver circuit, interface or interface circuit can be used for reading and writing codes/data, or the above-mentioned transceiver circuit, interface or interface circuit can be used for signal transmission or transfer.

In an implementation of the present disclosure, the processor 701 may be stored with a computer program 703, and the computer program 703 is executed by the processor 701, causing the communication device 70 to perform the method described in the above method embodiments. The computer program 703 may be solidified in the processor 701, in which case the processor 701 may be implemented by hardware.

In an implementation of the present disclosure, the communication device 70 may include a circuit, and the circuit may implement the functions of sending or receiving or communicating in the foregoing method embodiments. The processors and transceivers described in this disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication device described in the above embodiments may be the network device or the terminal device (e.g., the first terminal device in the above method embodiments), but the scope of the communication device described in this disclosure is not limited thereto, and the structure of the communication device may not be limited by FIG. 7. The communication device may be a stand-alone device or may be part of a larger device. For example, the communication device may be:
(1) a stand-alone integrated circuit IC, or chip, or chip system or subsystem;
(2) a set of one or more ICs. In embodiments of the present disclosure, the IC set may also include storage components for storing data and computer programs;
(3) an ASIC, such as a modem;
(4) a module that can be embedded in another device;
(5) a receiver, a terminal device, an intelligent terminal device, a cellular phone, a wireless device, a handheld device, a mobile unit, a vehicle-mounted device, a network device, a cloud device, an artificial intelligence device, and the like;
(6) others, etc.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure further provide a system for determining a sidelink duration. The system includes the communication device as the terminal device and the communication device as the network device in the embodiment of FIG. 6, or the system includes the communication device as the terminal device and the communication device as the network device in the embodiment of FIG. 7.

The present disclosure further provides a readable storage medium on which instructions are stored. When the instructions are executed by a computer, the functions of any of the above method embodiments are implemented.

The present disclosure further provides a computer program product, which, when been executed by a computer, implements the functions of any of the above method embodiments.

Embodiments of the present disclosure provide a method and apparatus for transmission enhancement, which may be applied to a Non-Terrestrial Network (NTN) communication system, provide a coverage enhancement scheme applied to a satellite communication system, effectively improve a coverage performance in a satellite communication scenario, and ensure the reliability of service transmission.

In a first aspect, embodiments of the present disclosure provide a method for transmission enhancement, which is performed by a terminal device. The method includes:
in response to an uplink transmission failure, determining, based on detected preset information, a transmission parameter for an uplink transmission; wherein the preset information includes a predefined signal sent by a network device, or downlink control information sent by the network device; and
performing the uplink transmission based on the determined transmission parameter.

In the technical solution, when determining that the uplink transmission fails, the terminal device may determine, based on the detected preset information, the transmission parameter for the uplink transmission, and perform the uplink transmission based on the determined transmission parameter, which can effectively improve the coverage performance in the satellite communication scenario, and ensure the reliability of the service transmission.

In an implementation of the present disclosure, the determining, based on the detected preset information, the transmission parameter for the uplink transmission includes: periodically detecting the predefined signal sent by the network device; and in response to the detected predefined signal, determining, based on a mapping relationship between a signal and an uplink transmission parameter, the transmission parameter for the uplink transmission corresponding to the predefined signal.

In an implementation of the present disclosure, the detecting the predefined signal sent by the network device includes: detecting, according to signal characteristic information and/or transmission time-frequency resource position information of the predefined signal that are learnt in advance, the predefined signal sent by the network device from a predefined signal set.

In an implementation of the present disclosure, the signal characteristic information and/or the transmission time-frequency resource position information are respectively predefined; or the signal characteristic information and/or the transmission time-frequency resource position information are respectively configured to the terminal device by the network device through a signaling.

In an implementation of the present disclosure, the method further includes: stopping detection of the predefined signal after determining that an uplink transmission is successful.

In an implementation of the present disclosure, the determining, based on the detected preset information, the transmission parameter for the uplink transmission includes: detecting downlink control information based on configuration information; and determining, based on the downlink control information, the transmission parameter for the uplink transmission.

In an implementation of the present disclosure, the configuration information includes at least one of: pilot information for the downlink control information; detection of a Downlink Control Information (DCI) type of the downlink control information; the number of detections; a resource position; and an aggregation level.

In an implementation of the present disclosure, the downlink control information includes indication information for the transmission parameter or personal position information.

In an implementation of the present disclosure, the method further includes: stopping detection of the downlink control information after determining that the uplink transmission is successful.

In an implementation of the present disclosure, the uplink transmission failure includes at least any of: no response signal for the uplink transmission being received within a predefined time; no preconfigured downlink control information being received within the predefined time; no preconfigured first data being received within the predefined time; and no preconfigured pilot information being received within the predefined time.

In an implementation of the present disclosure, no response signal for the uplink transmission being received within the predefined time includes: no Random Access Response (RAR) signal for a Physical Random Access Channel (PRACH) signal being received within the predefined time; or no feedback information for a preset transmission being received within the predefined time, wherein the preset transmission is that second data is sent by the terminal device.

In an implementation of the present disclosure, the predefined time is given in a protocol; or, the predefined time is notified by the network device to the terminal device through the signaling in advance; wherein the signaling includes at least any one of a higher layer signaling, a medium access control layer signaling and a physical layer signaling.

In a second aspect, embodiments of the present disclosure provide another method for transmission enhancement, which is applied to a network device. The method includes: sending a predefined signal to a terminal device; or sending configuration information to the terminal device.

In an implementation of the present disclosure, the method further includes: respectively configuring for the terminal device, through a signaling, signal characteristic information and/or transmission time-frequency resource position information of the predefined signal.

In an implementation of the present disclosure, the configuration information includes at least one of: pilot information for the downlink control information; detection of a Downlink Control Information (DCI) type of the downlink control information; the number of detections; a resource position; or an aggregation level.

In a third aspect, embodiments of the present disclosure provide a communication device with some or all of functions of the terminal device implementing the method described in the first aspect. For example, the function of the communication device may have functions in some or all of embodiments in the present disclosure, or may have a function for independently implementing any of embodiments in the present disclosure. The function may be implemented by hardware, or may be implemented by hardware executing corresponding software. The hardware or software includes one or more units or modules corresponding to the above functions.

In an implementation of the present disclosure, a structure of the communication device may include a transceiver module and a processing module. The processing module is configured to support the communication device to perform corresponding functions in the above method. The transceiver module is configured to support communication between the communication device and other devices. The communication device may further include a storage module coupled to the transceiver module and the processing module, and configured to store necessary computer programs and data for the communication device.

As an example, the processing module may be a processor, the transceiver module may be a transceiver or a communication interface, and the storage module may be a memory.

In a fourth aspect, embodiments of the present disclosure provide another communication device with some or all of functions of the network device implementing the method described in the second aspect. For example, the function of the communication device may have functions in some or all of embodiments in the present disclosure, or may have a function for independently implementing any of embodiments in the present disclosure. The function may be implemented by hardware, or may be implemented by hardware executing corresponding software. The hardware or software includes one or more units or modules corresponding to the above functions.

In an implementation of the present disclosure, a structure of the communication device may include a transceiver module and a processing module. The processing module is configured to support the communication device to perform corresponding functions in the above method. The transceiver module is configured to support communication between the communication device and other devices. The communication device may further include a storage module coupled to the transceiver module and the processing module, and configured to store necessary computer programs and data for the communication device.

As an example, the processing module may be a processor, the transceiver module may be a transceiver or a communication interface, and the storage module may be a memory.

In a fifth aspect, embodiments of the present disclosure provide a communication device, including a processor, wherein the processor, when calling a computer program in a memory, executes the method described in the first aspect.

In a sixth aspect, embodiments of the present disclosure provide a communication device, including a processor, wherein the processor, when calling a computer program in a memory, executes the method described in the second aspect.

In a seventh aspect, embodiments of the present disclosure provide a communication device, including a processor and a memory, wherein a computer program is stored in the memory, and the processor executes the computer program stored in the memory to cause the communication device to execute the method described in the first aspect.

In an eighth aspect, embodiments of the present disclosure provide a communication device, including a processor and a memory, wherein a computer program is stored in the memory, and the processor executes the computer program stored in the memory to cause the communication device to execute the method described in the second aspect.

In a ninth aspect, embodiments of the present disclosure provide a communication device, including a processor and an interface circuit, wherein the interface circuit is configured to receive code instructions and transmit them to the processor, and the processor is configured to run the code instructions to cause the communication device to execute the method described in the first aspect.

In a tenth aspect, embodiments of the present disclosure provide a communication device, including a processor and an interface circuit, wherein the interface circuit is configured to receive code instructions and transmit them to the processor, and the processor is configured to run the code instructions to cause the communication device to execute the method described in the second aspect.

In an eleventh aspect, embodiments of the present disclosure provide a communication system, including the communication device described in the third aspect and the communication device described in the fourth aspect, or including the communication device described in the fifth aspect and the communication device described in the sixth aspect, or including the communication device described in the seventh aspect and the communication device described in the eighth aspect, or including the communication device described in the ninth aspect and the communication device described in the tenth aspect.

In a twelfth aspect, embodiments of the present disclosure provide a computer-readable storage medium configured to store instructions used by the above terminal device, wherein the instructions, when executed, cause the terminal device to execute the method described in the first aspect.

In a thirteenth aspect, embodiments of the present disclosure provide a readable storage medium configured to store instructions used by the above network device, wherein the instructions, when executed, cause the network device to execute the method described in the second aspect.

In a fourteenth aspect, the present disclosure further provides a computer program product including a computer program, which, when running on a computer, causes the computer to execute the method described in the first aspect.

In a fifteenth aspect, the present disclosure further provides a computer program product including a computer program, which, when running on a computer, causes the computer to execute the method described in the second aspect.

In a sixteenth aspect, the present disclosure provides a computer program, which, when running on a computer, causes the computer to execute the method described in the first aspect.

In a seventeenth aspect, the present disclosure provides a computer program, which, when running on a computer, causes the computer to execute the method described in the second aspect.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

Those of ordinary skill in the art can understand that the first, second, and other numerical numbers involved in this disclosure are only distinctions made for convenience of description and are not used to limit the scope of the embodiments of the disclosure, nor to indicate the order.

At least one in the present disclosure can also be described as one or more, and the plurality can be two, three, four or more, which is not limited in the present disclosure. In the embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

The corresponding relationships shown in each table in this disclosure can be configured or predefined. The values of the information in each table are only examples and can be configured as other values, which is not limited by this disclosure. When configuring the correspondence between information and each parameter, it is not necessarily required to configure all the correspondences shown in each table. For example, in the table in this disclosure, the corresponding relationships shown in some rows may not be configured. For another example, appropriate deformation adjustments can be made based on the above table, such as splitting, merging, or the like. The names of the parameters shown in the titles of the above tables may also be other names understandable by the communication device, and the values or expressions of the parameters may also be other values or expressions understandable by the communication device. When implementing the above tables, other data structures can also be used, such as arrays, queues, containers, stacks, linear lists, pointers, linked lists, trees, graphs, structures, classes, heaps, hash tables, or the like.

Predefinition in this disclosure may be understood as definition, pre-definition, storage, pre-storage, pre-negotiation, pre-configuration, firming, or pre-burning.

Those of ordinary skill in the art will appreciate that the units and algorithm steps of each example described in conjunction with the embodiments disclosed herein can be implemented with electronic hardware, or a combination of computer software and electronic hardware. Whether these functions are implemented in hardware or software depends on the specific application and design restrictions of the technical solution. Those skilled in the art may implement the described functions using different methods for each specific application, but such implementations should not be considered to be beyond the scope of this disclosure.

Those skilled in the art can clearly understand that for the convenience and simplicity of description, the specific operating processes of the systems, devices and units described above can be referred to the corresponding processes in the foregoing method embodiments, which will not be described again here.

The above are only specific embodiments of the present disclosure, but the protection scope of the present disclosure is not limited thereto. Any changes or substitutions easily conceivable to those skilled in the art within the technical scope disclosed in the present disclosure should be covered by the protection scope of this disclosure. Therefore, the protection scope of the present disclosure should be subject to the protection scope of the claims.

1. A method for transmission enhancement, performed by a terminal device, and comprising:
determining that an uplink transmission fails; and
determining, based on detected preset information, a transmission parameter for the uplink transmission, wherein the preset information comprises a predefined signal sent by a network device or downlink control information sent by the network device; and
performing the uplink transmission based on the determined transmission parameter.

2. The method according to claim 1, wherein the determining, based on the detected preset information, the transmission parameter for the uplink transmission comprises:
periodically detecting the predefined signal sent by the network device;
determining that the predefined signal is detected; and
determining, based on a mapping relationship between a signal and an uplink transmission parameter, the transmission parameter for the uplink transmission corresponding to the predefined signal.

3. The method according to claim 2, wherein the periodically detecting the predefined signal sent by the network device comprises:
periodically detecting, according to at least one of signal characteristic information or transmission time-frequency resource position information of the predefined signal, the predefined signal sent by the network device from a predefined signal set, wherein the at least one of the signal characteristic information or the transmission time-frequency resource position information is learnt in advance; and
the at least one of the signal characteristic information or the transmission time-frequency resource position information are respectively is predefined; or
the at least one of the signal characteristic information or the transmission time-frequency resource position information is configured to the terminal device by the network device through a signaling.

4. (canceled)

5. The method according to claim 2, wherein the method further comprises:
determining that the uplink transmission is successful; and
stopping detection of the predefined signal.

6. The method according to claim 1, wherein the determining, based on the detected preset information, the transmission parameter for the uplink transmission comprises:
detecting the downlink control information based on configuration information; and
determining, based on the downlink control information, the transmission parameter for the uplink transmission.

7. The method according to claim 6, wherein the configuration information comprises at least one of:
pilot information for the downlink control information;
detection of a Downlink Control Information (DCI) type of the downlink control information;
a number of detections;
a resource position; or
an aggregation level;
wherein the downlink control information comprises indication information for the transmission parameter or personal position information.

8. (canceled)

9. The method according to claim 6, further comprising:
determining that the uplink transmission is successful; and
stopping detection of the downlink control information.

10. The method according to claim 1, wherein the uplink transmission failure comprises at least any one of:
no response signal for the uplink transmission being received within a predefined time;
no preconfigured downlink control information being received within the predefined time;
no preconfigured first data being received within the predefined time; or
no preconfigured pilot information being received within the predefined time;
wherein no response signal for the uplink transmission being received within the predefined time comprises one of:
no Random Access Response (RAR) signal for a Physical Random Access Channel (PRACH) signal being received within the predefined time; or
no feedback information for a preset transmission being received within the predefined time, wherein the preset transmission is that second data is sent by the terminal device.

11. (canceled)

12. The method according to claim 10, wherein:
the predefined time is given in a protocol; or,
the predefined time is notified by the network device to the terminal device through a signaling in advance, wherein the signaling comprises at least any one of a higher layer signaling, a medium access control layer signaling and a physical layer signaling.

13. A method for transmission enhancement, performed by a network device, and comprising:
sending one of a predefined signal or configuration information to a terminal device.

14. The method according to claim 13, wherein the method further comprises:
respectively configuring for the terminal device, through a signaling, at least one of signal characteristic information or transmission time-frequency resource position information of the predefined signal.

15. The method according to claim 13, wherein the configuration information comprises at least one of:
pilot information for the downlink control information;
detection of a Downlink Control Information (DCI) type of the downlink control information;
a number of detections;
a resource position; or
an aggregation level.

16. A communication device, comprising a processor and a memory, wherein a computer program is stored in the memory, and the processor is configured to execute the computer program to:
determine that an uplink transmission fails; and
determine, based on detected preset information, a transmission parameter for the uplink transmission, and perform the uplink transmission based on the determined transmission parameter, wherein the preset information comprises a predefined signal sent by a network device or downlink control information sent by the network device.

17. The communication device according to claim 16, wherein the processor is configured to:
periodically detect the predefined signal sent by the network device;
determine that the predefined signal is detected; and
determine, based on a mapping relationship between a signal and an uplink transmission parameter, the transmission parameter for the uplink transmission corresponding to the predefined signal.

18. The communication device according to claim 17, wherein the processor is configured to:
periodically detect, according to at least one of signal characteristic information or transmission time-frequency resource position information of the predefined signal, the predefined signal sent by the network device from a predefined signal set, wherein the at least one of the signal characteristic information or the transmission time-frequency resource position information is learnt in advance; and
the at least one of the signal characteristic information or the transmission time-frequency resource position information is predefined; or
the at least one of the signal characteristic information or the transmission time-frequency resource position information is configured to the terminal device by the network device through a signaling.

19-31. (canceled)

32. A communication device, comprising a processor and a memory, wherein a computer program is stored in the memory, and the processor executes the computer program stored in the memory to cause the communication device to execute the method according to claim 13.

33. A communication device, comprising: a processor and an interface circuit; wherein:
the interface circuit is configured to receive code instructions and transmit the code instructions to the processor; and
the processor is configured to run the code instructions to execute the method according to claim 1.

34. A communication device, comprising: a processor and an interface circuit; wherein
the interface circuit is configured to receive code instructions and transmit the code instructions to the processor; and
the processor is configured to run the code instructions to execute the method according to claim 13.

35. A non-transitory computer-readable storage medium configured to store instructions which, when executed, enable the method according to claim 1 to be implemented.

36. A non-transitory computer-readable storage medium configured to store instructions which, when executed, enable the method according to claim 13 to be implemented.
